(19) United States
(12) Patent Application Publication
(10) Pub. No.: US 2003/0208534 A1
(43) Pub. Date: Nov. 6, 2003

(54) Enhanced productivity electronic meeting system

(76) Inventor: Dennis Carmichael, Ann Arbor, MI (US)

Correspondence Address: John G. Posa, Gifford, Krass, Groh, Sprinkle,, Anderson & Citkowski, P.C., 280 N. Old Woodward Ave., Suite 400, Birmingham, MI, 48009-5394, US

(21) Appl. No.: 10/427,273

(22) Filed: May 1, 2003

Related U.S. Application Data
(60) Provisional application No. 60/377,919, filed on May 2, 2002.

(51) Int. Cl. G06F 15/16

(52) U.S. Cl. 709/203; 709/205

(57) ABSTRACT

An enhanced-productivity electronic meeting system environment integrates a multiplicity of meeting tools allowing a group of people to collaborate in a fluid and intuitive way, sharing ideas on a common workspace while preserving the privacy of individual notes and communications. In the preferred embodiment, participants interact through a set of tablet computers connected via a local-area wireless network to provide a superior alternative to handouts, presentations, whiteboards, and personal notepads, in a single, integrated system. The primary system components include a server application program interfaced to a document database and meeting controller application program, and a meeting clients program executing on the computer of each participant.

### REFERENCE TO RELATED APPLICATION

This application claims priority from U.S. Provisional Patent Application Serial No. 60/377,919, filed May 2, 2002, the entire content of which is incorporated herein by reference.

### FIELD OF THE INVENTION

This invention relates generally to distributed computing and, more particularly, to a networked environment based upon portable devices such as tablet computers that enhances meeting productivity.

### BACKGROUND OF THE INVENTION

A meeting is an opportunity for a group of individuals to interact and share information. In-person communications are often the single most effective way for a group of people to cooperatively discuss a specific topic or agenda. Meetings may be held to accomplish a wide variety of goals. For example, the goal may primarily be instructional, to allow an individual to present some information to a group, in order to educate or instruct them on the topic; or exploratory, to pose a question or problem and to explore the options for a solution, with the thought that “two heads are better than one. Or the goal may involve decision-making; that is, to describe a problem or situation with the goal of analyzing the possible solutions or courses of action and to select one for implementation, or to coordinate efforts by allowing a group or team that is working on a shared project to inform each other as to their current status, to request or offer help, or to raise and resolve issues.

Instructional meetings tend to be one-way presentations rather than open discussions, but they often include time for question-and-answer sessions that may involve multiple participants. Exploratory and decision-making meetings are heavily dependent on open communication and understanding amongst all of the attendees. Coordination meetings are typically the reverse of an instructional meeting, in which a number of people are sharing their information with one project leader or manager, although there is also the possibility of open discussion.

Of course, very few meetings are purely one of the above types. Most meetings are combinations of the above, covering multiple topics or changing from one type to another as they progress.

Existing meeting and group discussion tools fall into three categories: handouts, presentations, and whiteboards. These same tools have been used to convey and share information for decades, with very little change. In addition to these group tools, most meeting participants also bring in a small notepad and pen for taking personal notes.

A “handout” is simply a method of getting information in front of the meeting participants. These are generally pre-printed text pages, graphs, and documents that contain information important to the discussion or meeting goals. It is also common to pass out a meeting agenda, list of attendees, and a statement of the meeting goals. The handouts are given to each participant, and the facilitator may walk them through the document or use it for reference during the meeting, pointing out specific areas of interest or importance.

Like other existing meeting tools, handouts offer certain advantages but also present certain limitations. In terms of advantages, handouts provide something each participant can take away from the meeting. Participants can normally take notes directly on the handouts, adding reminders or explanatory notes, or highlighting specific areas of interest, and once the meeting is complete, participants can keep those pages that are important to them and discard or recycle the rest.

On the other hand, hardcopies of sensitive or secure documents can be hard to control. The facilitator must make sure that no copies leave the meeting room. The facilitator must have them printed ahead of time, and must manually distribute them prior to or during the meeting.

It is also difficult to create extra copies during the meeting, and unused copies are wasted. When the facilitator calls attention to a specific section or note, it can take some time for all of the participants to flip through the pages and locate the information. Corrections and changes must be hand-made by each participant on their own copies, and it can be a distraction as individuals flip through the handouts on their own.

Color documents are expensive to print, but black-and-white diagrams can be hard to read. Larger-sized documents are unwieldy or must be reduced, which can render them unreadable. Unless an electronic copy is made available (on disk or on a shared network location), the printed material cannot be easily copied into another document or e-mail.

Another tool typically used to convey information from one person to a group is a “presentation” or slide-show. This may be performed using cards or a flip-chart, but is now more commonly done with a computer and projector. This is a popular method due to the fact that information is better understood when it is presented graphically, and a computerized presentation can help retain the group's attention better than a speaker alone.

In terms of advantages, graphics, animations, and other effects have been proven to help convey information more quickly and effectively than words alone. When combined with a hardcopy, attendees have a printed record of the presentation for future reference. Slide shows and other sequenced events provide a structured approach to presenting the information.

However, presentations and slide-shows are essentially non-interactive. For best results, presentations must be accompanied by a hardcopy, but print versions of slide shows tend to be inefficient and poorly structured. If the room has to be darkened for the display to be readable, it can interfere with the participants' ability to take notes and read handouts.

Whiteboards are often used in meetings where most of the participants are expected to share information. Whiteboards offer significant collaborative capabilities. They allow a group of people to share a common drawing space, where each participant can graphically add their comments and input. The shared drawing space can be used for virtually any free-form drawing or writing, taking notes, highlighting specific points, etc.; all of these are excellent aids to conveying information and helping to improve understanding.

Whiteboards are normally set up so that they can be easily seen and/or accessed by all participants. They allow the use of multiple colors, drawing styles, and so on, which can make it easier to convey complex or multi-tiered information. The interface is as simple as sketching on a pad of paper; it is extremely simple and effective, and can be used by virtually anyone.

Although electronic whiteboards can provide printouts or computer graphic files, eliminating the need to transcribe the information by hand, most whiteboards do not capture information automatically, so important information must be transcribed by hand during or after the meeting. Even those boards which can produce a printout, the information may be hard to decipher without color, drawing order, and other inherent information. Another disadvantage is that to use a whiteboard, each person must get up and physically approach the board.

Whiteboards also require frequent cleaning and new supplies to keep them useful. All but the most advanced boards offer no way to make more space once the drawing area is filled. All drawing on a whiteboard or overhead is necessarily freehand; there are no shape templates and typing is not possible. There are no editing or “undo” capabilities. Once a graphic is drawn onto the workspace, the only options are to draw over it or erase it. Once erased, the markings are gone.

Some of the most advanced whiteboard systems now allow scrolling or multiple pages of information, along with simple editing and movement tools. These systems work through the use of a projector and special “pens” that are tracked by a computer to detect drawing and editing actions and to change the projected image accordingly. However, such systems are still relatively rare and very expensive, and they only address some of the shortfalls.

Notepads are commonly used by individual meeting participants to take personal notes during a meeting. Notepads allow participants to take notes and make reminders in a quick an easy format, solely for their own reference. They also allow each individual to take notes in their own format, quickly and easily, with possibly the simplest interface ever created (pen and paper). Notes are completely private, but can be easily shared with another person by passing the page to them.

Similar to whiteboard notes, however, personal notes are free-form and do not allow for any kind of editing or typing either during the meeting or afterwards. Personal notepads are typically limited to one color, one page style (lines vs. graph paper, etc.), limiting their usefulness in describing complex information. Individual pages of notes can become lost easily, unless they are carefully stored along with other project or meeting notes. As hardcopies, they cannot be easily copied into another document without scanning or transcribing them. Thus, they are difficult to share.

### SUMMARY OF THE INVENTION

Broadly, this invention resides in an enhanced-productivity electronic meeting system environment which integrates a multiplicity of meeting tools. The environment broadly provides an architecture and methods for a group of people to collaborate in a fluid and intuitive way, sharing ideas on a common workspace while preserving the privacy of individual notes and communications.

In the preferred embodiment, participants interact through a set of tablet computers connected via a local-area wireless network to provide a superior alternative to handouts, presentations, whiteboards, and personal notepads, in a single, integrated system.

The primary system components include a server application program interfaced to a document database and meeting controller application program, and a meeting clients program executing on the computer of each participant.

Prior to a meeting, server application program may be used to configure an event by selecting the time and location, documents, attendees, meeting type or style, and so forth. After the meeting, the program may be used to access meeting notes, group diagrams, and other documents used or created during the meeting. This application may also interface with other third-party applications, such as a meeting room scheduling tool or personnel database. The document database may be used to store documents, meeting notes and group diagrams, as well as other pertinent information “outside” documents used during the meeting.

The meeting controller application program manages the interaction between participants and provides the shared (i.e., projected) display for an active meeting. It receives documents and configuration information about a meeting from the server application prior to the meeting's start and, once the meeting is complete, it sends all new documents (i.e., meeting notes and group diagrams) back to the server.

The meeting client program provides the in-meeting functionality to the participants, including the ability to view and print documents, collaborate on group diagrams, and create personal meeting notes. It also provides access to various meeting management tools, including voting, signature capture, and access control. Although the meeting client program is primarily intended for tablet computers, this and the other system tools are applicable to other system types, including laptops, palm-based computers, and even desktops.

### BRIEF DESCRIPTION OF THE DRAWINGS

FIG. 1 is a simplified diagram that shows an architecture according to the invention along with important functions and capabilities;

FIG. 2 depicts a user interface associated with a the Meeting Controller used to create and edit meetings;

FIG. 3 shows how each attendee picks up a tablet and signs in when the meeting is underway and

FIG. 4 illustrate certain other features and advantages made possible by the invention.

### DETAILED DESCRIPTION OF THE INVENTION

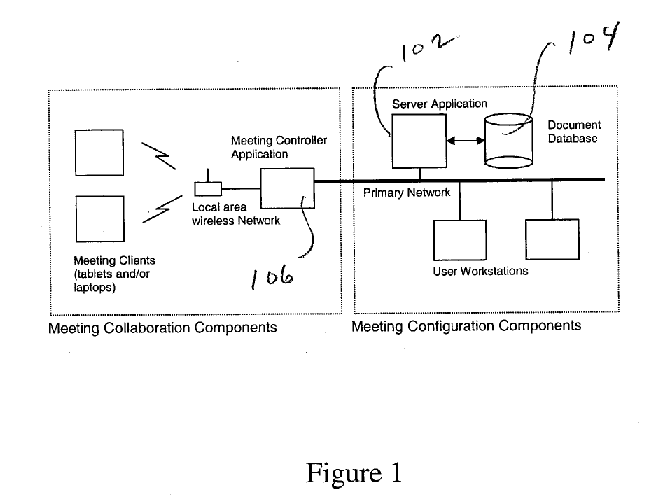

FIG. 1 is a simplified diagram that shows an architecture according to the invention along with important functions and capabilities. The primary system components include a Server Application 102, Document Database 104, Meeting Controller Application 106, and Meeting Clients Program 108. Each will be described in turn.

The Server Application 102 is a program that was designed to run on a networked server computer, and accessed via the network from individual user computers or workstations. Prior to a meeting, this program is used to configure an event by selecting the time and location, documents, attendees, meeting type or style, and so forth. After the meeting, the program is used to access Meeting Notes, Group Diagrams, and other documents used or created during the meeting. This application may also interface with other third-party applications, such as a meeting room scheduling tool or personnel database.

A Document Database 104 is preferably provided to the Server Application to store all documents associated with all meetings. This includes Meeting Notes and Group Diagrams, as well as “outside” documents used during the meeting.

The Meeting Controller Application 106 is a program that manages the interaction between participants within a single meeting, and provides the shared (i.e., projected) display for an active meeting. It receives documents and configuration information about a meeting from the Server Application prior to the meeting's start. Once the meeting is complete, it sends all new documents (i.e., Meeting Notes and Group Diagrams) back to the Server Application.

The Meeting Client program runs on each computer used in the meeting. This program was designed specifically for tablet computers, but may be used with other common system types such as laptops. The Meeting Client program provides the in meeting functionality to the participants, including the ability to view and print documents, collaborate on Group Diagrams, and create personal Meeting Notes. It also provides access to various meeting management tools, including voting, signature capture, and access control.

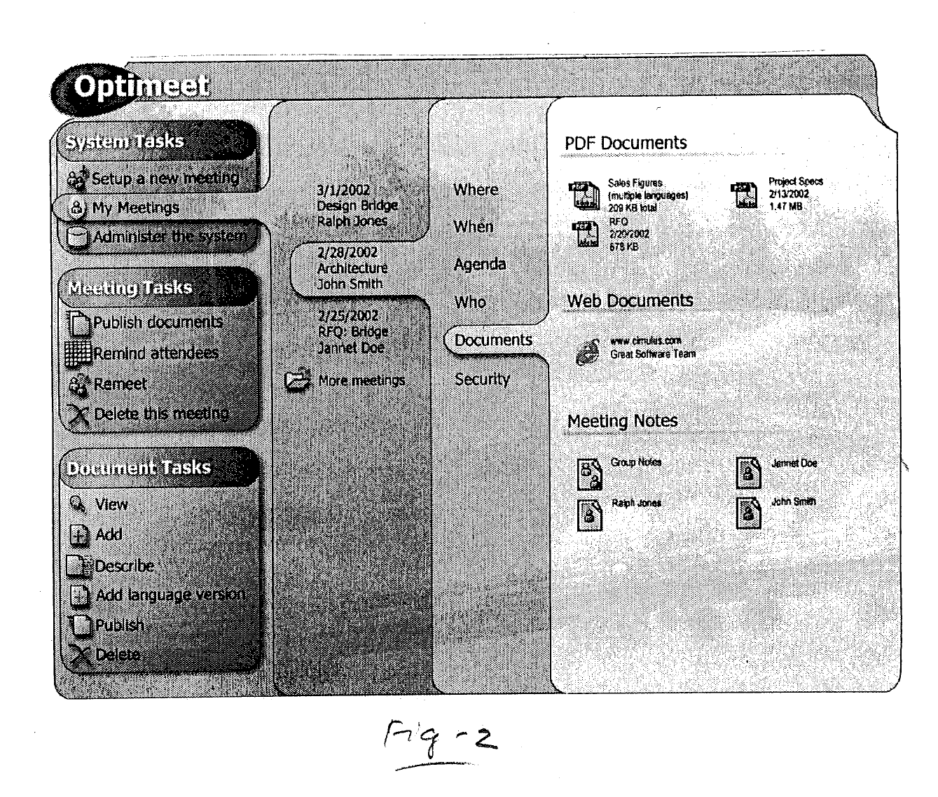

In conjunction with the other applications, the Meeting Controller is used to create and edit meetings through a simple, PC-based interface (see FIG. 2). This interface allows an organizer to perform functions such as:

Create and edit meetings, select a location and time, and name attendees,

Send invitations and reminders via e-mail,

Select documents for distribution at the meeting,

Set up security by document or attendee,

Build an agenda and schedule, including times for each item, and

Create forms that can be filled out or voted on during the event.

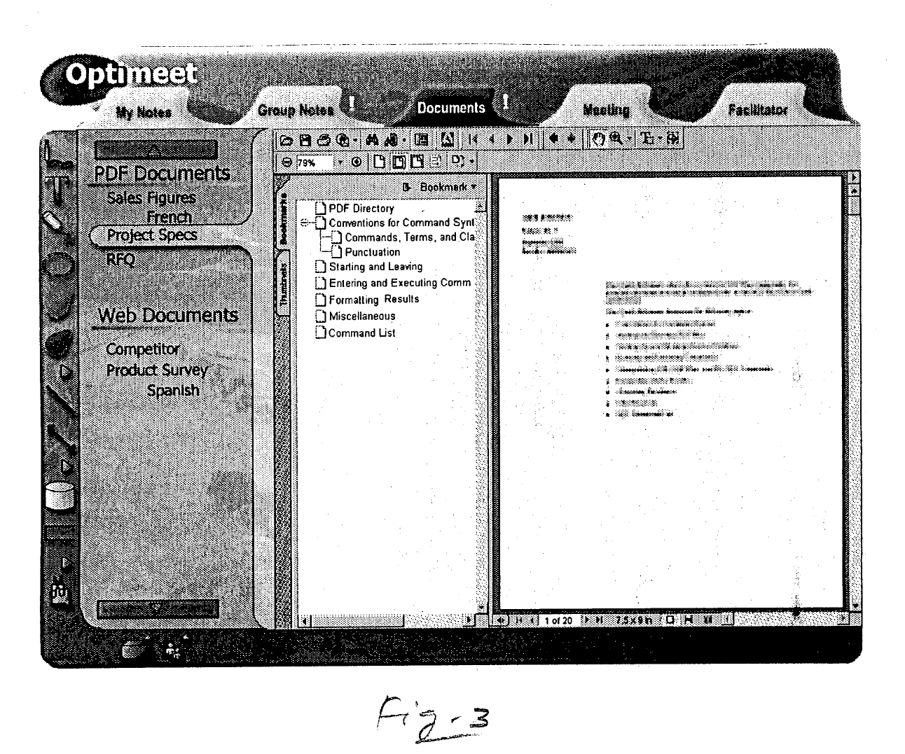

When the meeting is underway, each attendee picks up a tablet and signs in (see FIG. 3). The tablet is a notepad, handout and whiteboard all in one, allowing a user to perform at least the following functions:

Browse documents and take notes directly on-screen,

Force one or more attendees to view a specific document or page, even highlight sections or words,

Play a slide show, giving each attendee their own personal display, and

Print a page or document, even directly from the tablet (if allowed by the document's security)

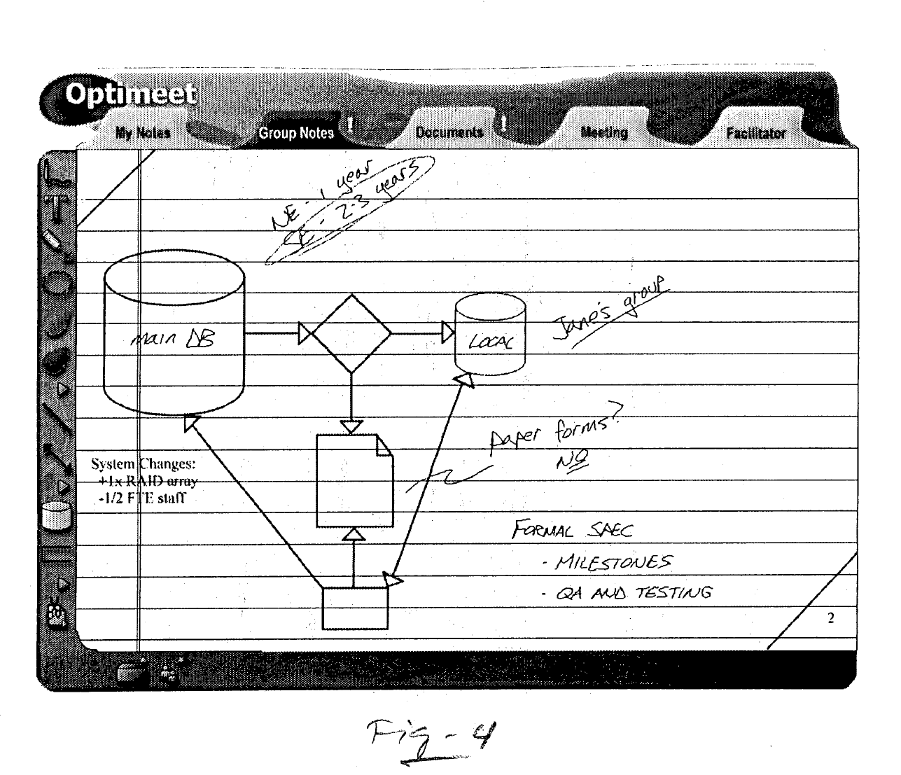

Additional features include the following (see FIG. 4):

The tablets all share a group workspace that allows freehand sketching, just like a standard whiteboard,

The workspace includes drawing tools, a variety of background images, and unlimited pages

Each tablet also has a personal notepad, just like the group workspace but stored in a private and secure file,

With network access, users can browse the network or even the Internet, to do quick research or retrieve a document, and

Users can share notes, copy pages between the workspaces, and other functions.

The system of the invention offers many advantages over current tools and methods. Meeting preparation time is reduced, since there is no longer any need to print and/or distribute documents ahead of time. Instead, the user must only select the electronic files that should be available during the meeting. In-meeting time is also reduced due to the increased efficiency of communications. For example, since a single participant may highlight a document section and automatically cause all other participants' tablets to display the same section, no time is lost while each participant searches through a printed document to find the section in question. Since each participant can use their tablet in place of a whiteboard, there is no need to get up and walk to the front of the room. Post-meeting time is reduced due. Because all information generated in the meeting is automatically captured electronically, there is no need to transcribe notes or the whiteboard when the meeting is complete. Distributing the resulting documents and/or graphics is also done electronically, so no printing or distribution of hardcopies is necessary.

In addition to time savings, the system affords better-control over numerous operations. Security of information is improved, since there are no printed copies of sensitive materials that need to be controlled before or after the meeting. Timing can be set and reflected on-screen on each of the tablets as a progress meter or clock to help the organizer keep on schedule. Facilitation is made much easier since the meeting organizer has the ability to retain control of all of the tablets, or to release control to another participant for a specific task.

Communication and organization are improved, and waste is reduced. The shared drawing space, which combines the advantages of a computerized drawing tool and a whiteboard, makes it easier for a group to collaborate on a diagram or workspace. Participants receive more accurate information since they all receive copies of the group-generated documentation after the meeting, rather than relying on only their personal notes. The use of computerized drawing tools makes rendering more readable and easier to understand than freehand drawings.

Notes are automatically stored with the meeting materials, both on a personal level for each attendee and for the entire meeting or team (i.e., encompassing a series of meetings). All materials generated in the meeting are digital and can be easily distributed and stored. In terms of waste reduction, there are no hardcopies of documents to discard or destroy after the meeting, and individual users do not need to bring their own notepads to meetings.

The system may be offered in two basic configurations: single-user, and complete. The single user system is the combination of a tablet computer, projector, and a specialized version of the tablet software. This system is meant as a superior replacement for a standard whiteboard (standard or electronic). It includes only the “group drawing area” and drawing tools, but does not provide the meeting set-up or follow-up capabilities, the document viewer, or the personal note spaces.

The multi-user system is the combination of two or more tablet computers with the tablet software on each one, and the meeting manager software installed on a server. It may also include a projector, printer, and/or an electronic whiteboard. The tables are each equipped with a small, short-distance wireless network connection, and the meeting room itself is equipped with a wireless hub and a local meeting server PC running a specialized version of the meeting manager software.

Handouts

The system is able to display common electronic documents, including PDF and MS Word files. Although these are displayed on-screen, in most instances they can be used just like a printed version: that is, the user can quickly thumb through the pages, take notes directly on the page or in the margins, highlight or circle items of interest, and so on. The advantages of this approach are many. The facilitator can control whether specific documents should be kept secure. Since there are no hardcopies, access and rights to the meeting documents can be electronically monitored and controlled. Once the facilitator has selected the documents for the meeting, there is no additional printing or preparation needed. Each tablet is pre-loaded with the required documents right before the meeting begins.

The facilitator can allow each person to flip through the documents on their own, or they can control which page or section is shown at any time. They can even highlight a specific part and force that highlight to show on all of the other tablets. Simple corrections and changes can be made right in the meeting, and the change reflected on each tablet immediately. All documents are automatically in color, and can be zoomed or resized to aid in readability. Individual attendees could even view different language versions of the documents.

Since the information is already in electronic form, it is very easy to copy segments into other documents, attach them to e-mails, and search for specific words or phrases. The documents can even contain animations and interactive sections, such as a small quiz or survey. With an optional in-room printer, participants can make complete or partial hardcopies as needed (provided the security setting allows it.)

Note that the “facilitator” features are not necessarily specific to one person. While this is useful in instructional meetings, the meeting organizer can elect to make these features available to just one person, select participants, or everyone in the meeting.

At the end of the meeting, instead of taking a printed copy away with them, the files can be automatically stored in a personalized folder that is available to the participant when they return to their desk. Their copy includes any notes or mark-ups they made, and can be accessed or discarded at any time after the meeting.

Presentations

Since each tablet is its own computer system, they can be used as “individual screens” for presentations or slide shows. And again, since each participant can take notes directly on the display, there is no need to provide a hardcopy for each person. Just as with handouts, each participant can be given access to the slide-show or presentation, along with any hand-written notes or annotations they made during the meeting, through a personal folder accessible from their desktop PC.

By giving each attendee their own display, slide shows and presentations can be made much more interactive, allowing or disallowing individual control over the progression through the material. In addition to allowing individual control, presentations using this system can actually include interactive elements, such as real-time surveys and votes. Since the tablets use the same kind of displays as modern laptops, there is much less of a need to reduce the room lighting for readability.

Whiteboards

The system's true collaborative capabilities are best demonstrated with the group workspace feature. This workspace can replace or supplement a whiteboard or other general drawing surface. It can be used with a projector, so that all of the participants can view the workspace just as if it were an overhead or a whiteboard, or it can simply operate as a “shared notepad” that each user can view on their tablet.

As with a “real” whiteboard, the shared workspace can be used for virtually any free-form drawing or writing, taking notes, highlighting specific points, and so on. Since each participant has their own display, there is no need to change position or arrange seating to make the central board visible. The interface remains just as simple as a real whiteboard: the participants just draw directly on the screen, and their edits show up on all of the shared displays immediately.

Since the system is entirely digital, all information is captured automatically into a graphic file, including what is drawn in what color, in what order, and even by which individual. No transcription is necessary. There is no need for anyone to get out of their seat to add to the drawing, and no pens, cleaners, or other supplies are needed. There are an unlimited number of pages available, and the participants can flip between them at will. They can even move notes around on a page to make room, or copy and paste information from one page to another.

In addition to freehand drawing, the system offers pallets of common shapes and symbols, as well as common graphical drawing tools such as lines and curves. It also allows participants to edit the information already on the board, selectively moving, resizing, erasing or changing objects on the display. The addition of a keyboard allows the facilitator or a participant to add typed notes directly to the workspace. More advanced systems can even incorporate handwriting recognition.

Again, the system can be set up for each meeting to give full control to the meeting facilitator, who can then decide which participant has the ability to add or edit notes at any given time, or it can be configured to allow free and concurrent access by all attendees at once, depending on the meeting goals and purpose.

Notepads

To provide a complete meeting environment, the system not only offers shared tools and collaborative workspaces, but also a private notepad as well. This feature is in many ways very similar to the group workspace, in that it allows free-form drawing and annotation; however, the information that is captured remains private and local to that participant's tablet—unless they chose to share.

Just like a private notepad, the system allows the user to take notes in their own format, using the same interface: namely, a pen drawing directly on the display. Notes are completely private and stored after the meeting along with the participant's copy of the meeting notes and materials in their personal directory. They can even be encrypted if necessary, to prevent access by unauthorized individuals. Since the notepad is completely digital, it can offer unlimited pages as well as different background styles (i.e., lined vs. graph paper, yellow vs. white) to suit the individual and type of notes they are taking at the time.

During the meeting, participants can share their notes by sending a copy of a page to others in the meeting; they show up as additional pages in their own notepad. In addition to free-form notes, the system provides the same advantages as the group workspace: multiple colors and styles, templates for common shapes and symbols, onscreen editing, and even handwriting recognition. All notes are captured and saved automatically along with the other meeting information, ensuring that nothing gets lost or misfiled. Since the notes are electronic images from the start, they can be easily copied into other documents, sent via e-mail, or even printed as hardcopies. Depending on the system configuration, notes from previous meetings can even be made available to each participant as they “sign on” for a meeting.

Additional Features

In addition to the primary systems described above, the invention can be configured to support a wide range of other useful features and capabilities. For example, the tablets may include a pop-up calculator, thesaurus and dictionary. Meeting schedules and agendas can be set ahead of time, with time limits set for specific topics and shown as an on-screen clock or progress meter. Interactive pages can be added to note attendance or take votes, even capturing a signature. Networking adds the possibility of accessing other files and folders, sending and receiving e-mail, or even researching the Web during the meeting. A complete meeting history is captured and stored for future reference or replay. And since the platform for the system is all standard PC operating systems and hardware, it can be customized to suite virtually any special need or application.

I claim:

1. An enhanced-productivity electronic meeting system environment utilizing a plurality of networked portable computers, each equipped with a display and a user interface, the system comprising:
a server application program running on one of the computers for developing meeting configuration information, including the identification of useful documents; and
a meeting client application program running on each one of the computers enabling each participant to view the documents and take notes during the meeting.

2. The enhanced-productivity electronic meeting system environment of claim 1, wherein one or more of the computers are tablet computers.

3. The enhanced-productivity electronic meeting system environment of claim 1, wherein the meeting configuration information includes the time and location of the meeting.

4. The enhanced-productivity electronic meeting system environment of claim 1, wherein the meeting configuration information includes a list of attendees.

5. The enhanced-productivity electronic meeting system environment of claim 1, wherein the meeting configuration information includes the type or style of the meeting.

6. The enhanced-productivity electronic meeting system environment of claim 1, wherein server application program is further operative to collect and distribute documents and other information to participants at the conclusion of a meeting.

7. The enhanced-productivity electronic meeting system environment of claim 6, wherein the other information includes notes generated by participants.

8. The enhanced-productivity electronic meeting system environment of claim 6, wherein the other information includes group diagrams generated by participants.

9. The enhanced-productivity electronic meeting system environment of claim 1, wherein server application program is further operative to interface with computers other than the networked portable computers to access applications useful to a meeting.

10. The enhanced-productivity electronic meeting system environment of claim 1, further including a meeting controller application running on one of the computers to receive documents and configuration information from the server application program and manage interactions among the participants through the meeting client application programs running on each computer.

11. The enhanced-productivity electronic meeting system environment of claim 10, wherein the meeting controller application is further operative to provide the shared display common to all meeting participants.

12. The enhanced-productivity electronic meeting system environment of claim 10, wherein the meeting controller application is further operative to transmit documents and other information to the server application for distribution to the participants at the conclusion of a meeting.

13. The enhanced-productivity electronic meeting system environment of claim 10, wherein the other information includes notes generated by participants.

14. The enhanced-productivity electronic meeting system environment of claim 10, wherein the other information includes notes generated by participants.

15. The enhanced-productivity electronic meeting system environment of claim 10, wherein the meeting controller application provides access to one or more meeting management tools.

16. The enhanced-productivity electronic meeting system environment of claim 15, wherein the meeting management tools facilitate voting, signature capture, or control access to a meeting.

17. An enhanced-productivity electronic meeting system environment utilizing a plurality of networked portable computers, each equipped with a display and a user interface, the system comprising:
a server application program running on one of the computers for developing meeting configuration information, including the identification of useful documents;
a meeting client application program running on each one of the computers enabling each participant to view the documents and take notes during the meeting; and
a meeting controller application running on one of the computers to receive documents and configuration information from the server application program and manage interactions among the participants through the meeting client application programs running on each computer.

18. The enhanced-productivity electronic meeting system environment of claim 17, wherein one or more of the computers are tablet computers.

19. The enhanced-productivity electronic meeting system environment of claim 17, wherein the meeting configuration information includes the time and location of the meeting.

20. The enhanced-productivity electronic meeting system environment of claim 17, wherein the meeting configuration information includes a list of attendees.

21. The enhanced-productivity electronic meeting system environment of claim 17, wherein the meeting configuration information includes the type or style of the meeting.

22. The enhanced-productivity electronic meeting system environment of claim 17, wherein the meeting controller application is further operative to provide the shared display common to all meeting participants.

23. The enhanced-productivity electronic meeting system environment of claim 17, wherein the meeting controller application is further operative to transmit documents and other information to the server application for distribution to the participants at the conclusion of a meeting.

24. The enhanced-productivity electronic meeting system environment of claim 23, wherein the other information includes notes generated by participants.

25. The enhanced-productivity electronic meeting system environment of claim 23, wherein the other information includes notes generated by participants.

26. The enhanced-productivity electronic meeting system environment of claim 17, wherein the meeting controller application provides access to one or more meeting management tools.

27. The enhanced-productivity electronic meeting system environment of claim 26, wherein the meeting management tools facilitate voting, signature capture, or control access to a meeting.

28. An enhanced-productivity electronic meeting system environment, comprising:
a plurality of portable computers, each equipped with a display and a user interface for each participant of a meeting;
a local-area network interconnecting the computers;
meeting management software running on at least one of the computers for managing interactions among the participants and identifying useful documents; and
a meeting client application program running on each one of the computers enabling each participant to view the documents and take notes during the meeting.

29. The enhanced-productivity electronic meeting system environment of claim 28, wherein one or more of the computers are tablet computers.

30. The enhanced-productivity electronic meeting system environment of claim 28, wherein the meeting management software provides for meeting set-up and follow-up.

31. The enhanced-productivity electronic meeting system environment of claim 28, wherein the computers are further interfaced to a display projector for viewing documents and other information.

32. The enhanced-productivity electronic meeting system environment of claim 28, wherein the computers are further interfaced to a printer for printing documents and other information.

33. The enhanced-productivity electronic meeting system environment of claim 28, wherein the computers are further interfaced to an electronic whiteboard.

34. The system of claim 10, enhanced-productivity electronic meeting system environment of claim 28, wherein the network is wireless.
